(19) United States
(12) Patent Application Publication
(10) Pub. No.: US 2015/0041602 A1
(43) Pub. Date: Feb. 12, 2015

(54) Corner Button to Protect a Touch Screen

(71) Applicant: Fuhu Holdings, Inc., El Segundo, CA (US)

(72) Inventor: Robb Fujioka, Manhattan Beach, CA (US)

(21) Appl. No.: 14/453,561

(22) Filed: Aug. 6, 2014

Related U.S. Application Data
(60) Provisional application No. 61/862,899, filed on Aug. 6, 2013.

(51) Int. Cl. F16M 11/22; H01H 11/00

(52) U.S. Cl. CPC F16M 11/22; H01H 11/00
USPC 248/176.1; 29/622

(57) ABSTRACT

A corner button to protect a touch screen is disclosed. According to one embodiment, an apparatus includes a cylindrical body that is configured to be inserted into a correspondingly shaped cavity in an exterior case of a tablet computer, where a longitudinal portion of the cylindrical body is configured to remain outside the exterior case, and the longitudinal portion is configured to support a touch screen of the tablet computer above a surface. The apparatus includes a first groove directed along a diameter of a first circular surface of the cylindrical body, where the first groove is configured to engage with a structural member within the cavity. The apparatus further includes one or more protruding members that extend distally from the first circular surface of the cylindrical body, wherein each of the one or more protruding members is configured to be fixedly seated into a corresponding hole within the cavity.

### CROSS-REFERENCE TO RELATED APPLICATIONS

The present application claims priority to U.S. Provisional Patent Application No. 61/862,899 filed on Aug. 6, 2013, entitled “Corner Button to Protect a Touch Screen”, which is herein incorporated by reference.

### FIELD

The present disclosure relates in general to a protective button for an electronic device. In particular, the present disclosure relates to a corner button to protect a touch screen.

### BACKGROUND

Recent advances in electronics and communications systems have introduced various portable electronic devices, for example, cell phones, portable audio players, and tablet computers. These portable electronic devices are enjoyed by users every day around the world. A large percentage of portable electronic devices include a touch screen, which eliminates the need for a peripheral input device, for example, a keyboard, a mouse, and a stylus. Unfortunately, the touch screen is typically delicate and easily damaged when the portable electronic device is dropped, bumped, and/or suffer an impact. For example, when a touch screen device (e.g., a cell phone and a tablet computer) is dropped, the touch screen can easily shatter. The touch screen may also be damaged when placed screen-down on a tabletop or a desk. Particulate matter and liquids on the tabletop or the desk may crack, scrape, or seep into the touch screen. Repairing the touch screen is time consuming and costly to the user.

### SUMMARY

A corner button to protect a touch screen is disclosed. According to one embodiment, an apparatus includes a cylindrical body that is configured to be inserted into a correspondingly shaped cavity in an exterior case of a tablet computer, where a longitudinal portion of the cylindrical body is configured to remain outside the exterior case, and the longitudinal portion is configured to support a touch screen of the tablet computer above a surface. The apparatus includes a first groove directed along a diameter of a first circular surface of the cylindrical body, where the first groove is configured to engage with a structural member within the cavity. The apparatus further includes one or more protruding members that extend distally from the first circular surface of the cylindrical body, wherein each of the one or more protruding members is configured to be fixedly seated into a corresponding hole within the cavity.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying drawings, which are included as part of the present specification, illustrate the various embodiments of the present disclosed system and method and together with the general description given above and the detailed description of the preferred embodiment given below serve to explain and teach the principles of the present disclosure.

FIG. 1 illustrates an upper isometric view of an exemplary corner button, according to one embodiment;

FIG. 2 illustrates a lower isometric view of an exemplary corner button, according to one embodiment;

FIG. 3 illustrates a lateral profile view of an exemplary corner button, according to one embodiment;

FIG. 4 illustrates an anterior profile view of an exemplary corner button, according to one embodiment;

FIG. 5 illustrates a posterior profile view of an exemplary corner button, according to one embodiment;

FIG. 6 illustrates a proximal view of an exemplary corner button, according to one embodiment; and

FIG. 7 illustrates a distal view of an exemplary corner button, according to one embodiment.

It should be noted that the figures are not necessarily drawn to scale and that elements of structures or functions are generally represented by reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A corner button to protect a touch screen is disclosed. According to one embodiment, an apparatus includes a cylindrical body that is configured to be inserted into a correspondingly shaped cavity in an exterior case of a tablet computer, where a longitudinal portion of the cylindrical body is configured to remain outside the exterior case, and the longitudinal portion is configured to support a touch screen of the tablet computer above a surface. The apparatus includes a first groove directed along a diameter of a first circular surface of the cylindrical body, where the first groove is configured to engage with a structural member within the cavity. The apparatus further includes one or more protruding members that extend distally from the first circular surface of the cylindrical body, wherein each of the one or more protruding members is configured to be fixedly seated into a corresponding hole within the cavity.

In the following description, for purposes of clarity and conciseness of the description, not all of the numerous components shown in the schematic are described. The numerous components are shown in the drawings to provide a person of ordinary skill in the art a thorough enabling disclosure of the present system and method. The operation of many of the components would be understood to one skilled in the art.

Each of the additional features and teachings disclosed herein can be utilized separately or in conjunction with other features and teachings to provide a corner button to protect a touch screen of a tablet computer. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples.

According to one embodiment, the present system and method provides a corner button to protect a touch screen of a tablet computer. The corner button has a cylindrical body made of a pliable material and is configured to be partially inserted into a cavity in an exterior case of the tablet computer. A portion of the cylindrical body remains exposed outside the case. The exposed portion of the corner button operates as a foot that supports the tablet computer when the tablet computer is placed screen-down on a horizontal surface, for example a tabletop or a desk. The cylindrical body has an interior cavity that is configured to mount onto a pedestal within the exterior case of the tablet computer. In addition, the corner button has one or more distally protruding members that are each configured for insertion into holes inside the exterior case of the tablet computer. The interior cavity and the protruding members keep the corner button retained within the exterior case of the tablet computer.

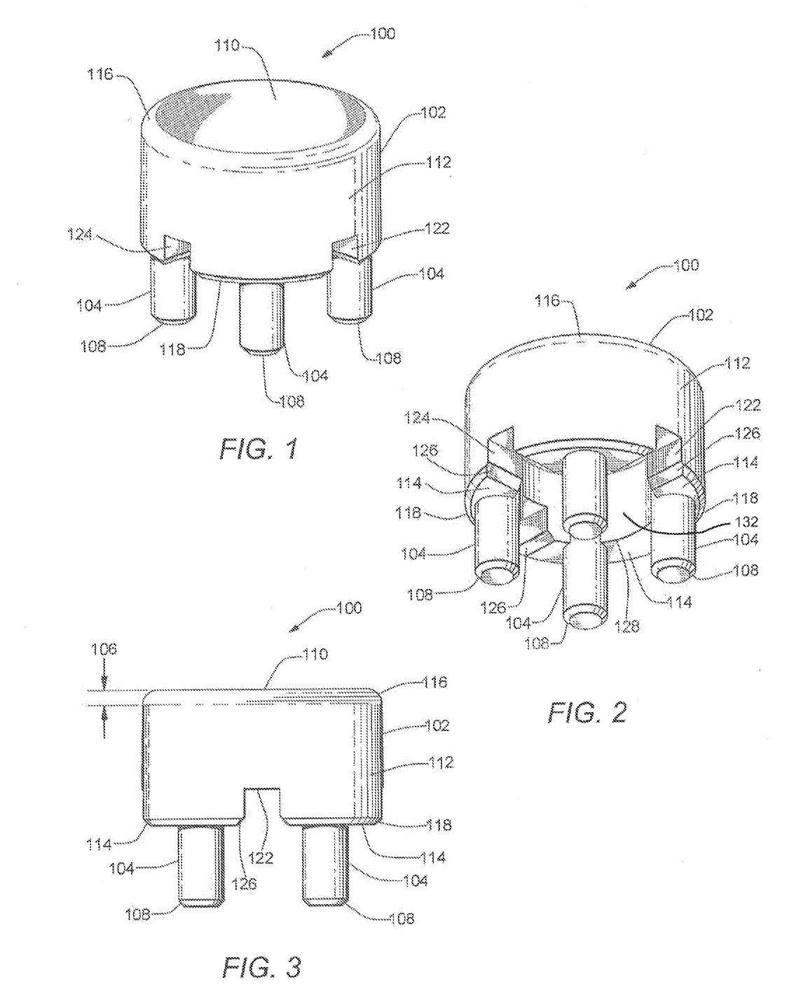

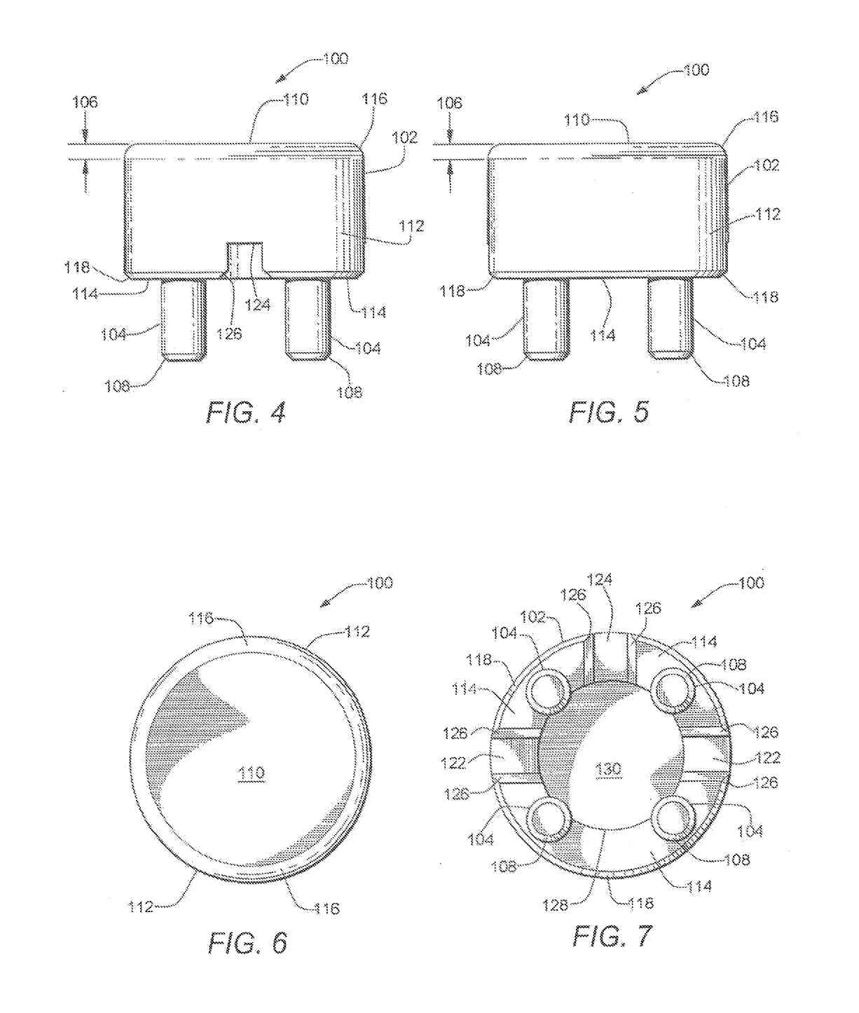

FIGS. 1-7 illustrate respectively an upper isometric view, a lower isometric view, a lateral profile view, an anterior profile view, a posterior profile view, a proximal view, and a distal view of an exemplary corner button, according to one embodiment. The corner button 100 is made of a pliable material and is configured to be attached to an exterior case of a tablet computer (not shown) to provide protection to the touch screen of the tablet computer. The pliable material may be any flexible material, including, but not limited to, rubber, silicone, and polyurethane. The corner button 100 includes a cylindrical body 102 and a plurality of protruding members 104 that extend distally from the cylindrical body 102.

Referring to FIG. 3, the cylindrical body 102 has a size that is configured for being inserted into a correspondingly shaped cavity in the exterior case of the tablet computer such that an upper longitudinal portion 106 of the cylindrical body 102 remains outside the exterior case of the tablet computer. The longitudinal portion 106 supports and raises at least a portion of the touch screen above a horizontal surface, for example, a tabletop or a desk, when the tablet computer is placed screen-down on the horizontal surface. This provides protection to the touch screen. It is understood that the proportion of the upper longitudinal portion 106 with respect to the height of the cylindrical body 102 may vary without deviating from the scope of the present disclosure.

Each protruding member 104 is suitably configured to be fixedly seated into a hole in the exterior case of the tablet computer. Each of the protruding members 104 is cylindrical, and has a specified diameter and length for being fixedly seated into the hole in the exterior case of the tablet computer. According to one embodiment, the protruding member 104 has a distal chamfer 108 that facilitates an entry of the protruding member 104 into the hole in the exterior case of the tablet computer. In one embodiment, the chamfer 108 has rounded edges. In another embodiment, the protruding member 104 does not have a chamfer 108. It is appreciated by those of ordinary skill in the art that the corner button 100 may include any number of protruding members 104 that are of the same or different shapes and sizes without deviating from the scope of the present disclosure.

Referring to FIGS. 1 and 2, the cylindrical body 102 includes a proximal flat surface 110, a curved side surface 112, and a distal flat surface 114. The proximal flat surface 110 further includes a peripheral portion 116 that transitions to the curved side surface 112. According to one embodiment, the peripheral portion 116 is rounded such that the proximal flat surface 110 smoothly joins the curved side surface 112. In another embodiment, the peripheral portion 116 includes a peripheral chamfer. In another embodiment, the peripheral portion 116 is a sharp edge that is characterized by a substantially right angle. According to one embodiment, the peripheral portion 116 is sized to include the upper longitudinal portion 106. It is noted that the proximal flat surface 110 may include an embossed or depressed distinguishing symbol, for example, a company logo, a textual character, and a trademark.

The distal flat surface 114 further includes a peripheral portion 118 that transitions to the curved side surface 112. According to one embodiment, the peripheral portion 118 includes a peripheral chamfer. In another embodiment, the peripheral portion 118 is rounded such that the distal flat surface 114 smoothly joins the curved side surface 112. The peripheral portion 118 in the form of a chamfer or a rounded surface allows the corner button 100 to be easily inserted into the exterior case of the tablet computer. In another embodiment, the peripheral portion 118 has a sharp edge that is characterized by a substantially right angle.

The cylindrical body 102 further includes one or more first grooves 122 and a second groove 124 that are configured to engage with structural members within the cavity of the tablet computer (not shown). Referring to FIG. 7, the first grooves 122 are aligned along a diameter of the cylindrical body 102 and the second groove 124 is aligned at an angle to the first grooves 122. In one embodiment, the second groove 124 is perpendicular to the first grooves 122. In another embodiment, the second groove 124 is at an angle to the first grooves 122. The first grooves 122 and the second groove 124 further include chamfered edges 126. The chamfered edges 126 allow the first grooves 122 and the second groove 124 to be easily engaged with the structural members within the cavity of the tablet computer. In another embodiment, the first grooves 122 and the second groove 124 do not have the chamfered edges 126.

Referring to FIGS. 2 and 7, the cylindrical body 102 includes an open chamber 128 in the distal flat surface 114 that extends into the cylindrical body 102. The open chamber 128 is configured to fixedly engage with a structural pedestal within the cavity of the tablet computer (not shown). The open chamber 128 includes a concentric cylindrical volume that is centered within the cylindrical body 102 to carve an inner cavity wall 130 and a side cavity wall 132 within the cylindrical body 102. The open cavity 127 further includes a concentric cylindrical volume positioned within the cylindrical body 102 such that a first thickness between the proximal flat surface 110 and the inner cavity wall 130 and a second thickness between the curved side surface 112 and the side cavity 132 are the same. It is appreciated by those skilled in the art that the open chamber 128 may be of any type of volume as long as the open chamber 128 fixedly engages with the structural pedestal within the cavity of the tablet computer. The open chamber 128 may include other types of volumes, including, but not limited to, a cubic volume and a spherical volume. It is noted that the upper wall 130 and the side wall 132 may be of a different thickness without deviating from the scope of the present disclosure.

According to one embodiment, the present corner button is configured to be attached to a protective case of a tablet computer or directly to a tablet computer to support the display screen of the tablet computer above a horizontal support surface and protect the display screen from damage caused by particulate matter and liquid. In one embodiment, three corner buttons 100 are used as feet to support the tablet computer above the support surface. In another embodiment, two corner buttons 100 are installed onto two adjacent comers of the tablet computer and a third corner button 100 is installed onto a side of the tablet computer that is opposite to the two adjacent comers. In another embodiment, four corner buttons 100 are used as feet to support the tablet computer above the support surface, where one corner button 100 is installed onto each of the four comers of the tablet computer. It will be appreciated by those skilled in the art that any number of corner buttons 100 may be used to support the tablet computer without deviating from the scope of the present disclosure.

The above example embodiments have been described hereinabove to illustrate various embodiments of a corner button to protect a touch screen of a tablet computer. Various modifications and departures from the disclosed example embodiments will occur those having ordinary skill in the art. The subject matter that is intended to be within the scope of the disclosure is set forth in the following claims.

I claim:

1. An apparatus, comprising:
a cylindrical body that is configured to be inserted into a correspondingly shaped cavity in an exterior case of a tablet computer,
wherein a longitudinal portion of the cylindrical body is configured to remain outside the exterior case,
wherein the longitudinal portion is configured to support a touch screen of the tablet computer above a surface;
a first groove directed along a diameter of a first circular surface of the cylindrical body, wherein the first groove is configured to engage with a structural member within the cavity; and
one or more protruding members that extend distally from the first circular surface of the cylindrical body, wherein each of the one or more protruding members is configured to be fixedly seated into a corresponding hole within the cavity.

2. The apparatus of claim 1, further comprising a second groove directed along the diameter of the first circular surface of the cylindrical body, wherein the second groove is configured to engage with the structural member within the cavity.

3. The apparatus of claim 2, wherein the second groove is aligned at an angle to the first groove.

4. The apparatus of claim 2, wherein the second groove is perpendicular to the first groove.

5. The apparatus of claim 2, wherein one or more of the first groove and the second groove include a chamfered edge.

6. The apparatus of claim 1, further comprising an open chamber in the first circular surface that extends into the cylindrical body, wherein the open chamber is configured to fixedly engage with a structural pedestal within the cavity.

7. The apparatus of claim 1, wherein the open chamber includes a concentric cylindrical volume positioned with the cylindrical body, wherein the open chamber creates an inner wall in the cylindrical body that is parallel to a second circular surface of the cylindrical body, wherein the open chamber creates an inner side wall in the cylindrical body that is parallel to a curved side surface of the cylindrical body, and wherein a first thickness between the inner wall and the second circular surface and a second thickness between the inner side wall and the curved side surface is the same.

8. The apparatus of claim 1, wherein a second circular surface of the cylindrical body includes a peripheral portion along a circumference of the second circular surface, wherein the peripheral portion transitions to a curved side surface of the cylindrical body.

9. The apparatus of claim 8, wherein the peripheral portion is one of a chamfer, a rounded peripheral portion, and a sharp edge characterized by a right angle.

10. The apparatus of claim 8, wherein the longitudinal portion is within the peripheral portion.

11. The apparatus of claim 1, wherein the cylindrical body is made of a pliable material, wherein the pliable material is one or more of silicone, rubber, and polyurethane.

12. A method, comprising:
forming a corner button that includes a cylindrical body that is configured to be inserted into a correspondingly shaped cavity in an exterior case of a tablet computer,
wherein a longitudinal portion of the cylindrical body is configured to remain above a surface of the exterior case,
wherein the longitudinal portion is configured to support a touch screen of the tablet computer above a surface;
forming a first groove directed along a diameter of a first circular surface of the cylindrical body, wherein the first groove is configured to engage a structural member within the cavity; and
forming one or more protruding members that extend distally from the first circular surface of the cylindrical body, wherein each of the one or more protruding members is configured to be fixedly seated into a corresponding hole within the cavity.

13. The method of claim 12, further comprising forming a second groove directed along the diameter of the first circular surface of the cylindrical body, wherein the second groove is configured to engage with the structural member within the cavity.

14. The method of claim 13, further comprising aligning the second groove at an angle to the first groove.

15. The method of claim 13, further comprising aligning the second groove perpendicular to the first groove.

16. The method of claim 13, further comprising forming a chamfered edge at one or more of the first groove and the second groove.

17. The method of claim 12, further comprising forming an open chamber in the first circular surface that extends into the cylindrical body, wherein the open cavity is configured to fixedly engage with a structural pedestal within the cavity.

18. The method of claim 12, wherein forming the open chamber includes forming a concentric cylindrical volume positioned with the cylindrical body, wherein the open chamber creates an inner wall in the cylindrical body that is parallel to a second circular surface of the cylindrical body, wherein the open chamber creates an inner side wall in the cylindrical body that is parallel to a curved side surface of the cylindrical body, and wherein a first thickness between the inner wall and the second circular surface and a second thickness between the inner side wall and the curved side surface is the same.

19. The method of claim 12, further comprising forming a peripheral portion along a circumference of a second circular surface of the cylindrical body, wherein the peripheral portion transitions to a curved side surface of the cylindrical body.

20. The method of claim 19, wherein the peripheral portion is one of a chamfer, a rounded peripheral portion, and a sharp edge characterized by a right angle.

21. The method of claim 19, wherein the longitudinal portion is within the peripheral portion.

22. The method of claim 12, wherein the cylindrical body is made of a pliable material, wherein the pliable material is one or more of silicone, rubber, and polyurethane.
